(19) United States
(12) Patent Application Publication
(10) Pub. No.: US 2026/0215465 A1
(43) Pub. Date: Jul. 30, 2026

(54) VISION-BASED FOOD PRODUCT REFORMULATION

(71) Applicant: General Mills, Inc., Minneapolis, MN (US)

(72) Inventors: Alexander KNOPF, Golden Valley, MN (US); Olivia MURCH, Minneapolis, MN (US)

(73) Assignee: GENERAL MILLS, INC., Minneapolis, MN (US)

(21) Appl. No.: 19/144,646

(22) PCT Filed: Jan. 4, 2024
(86) PCT No.: PCT/US2024/010305

§ 371 Date: Jun. 30, 2025

Related U.S. Application Data
(60) Provisional application No. 63/437,455, filed on Jan. 6, 2023.

(51) Int. Cl. A23L 7/126; G05B 13/02

(52) U.S. Cl. CPC A23L 7/126; G05B 13/0265

(57) ABSTRACT

A method can include obtaining a set of images of a food product. The method can further include applying a trained machine learning model to the set of images to identify a feature of the food product. The method can further include modifying a formulation of the food product in response to identifying the feature.

### CROSS-REFERENCE TO RELATED APPLICATION

This application claims priority to U.S. provisional Ser. No. 63/437,455, filed Jan. 6, 2023, which is herein incorporated by reference in its entirety.

### FIELD

The present disclosure relates to food product manufacturing, and more specifically to food product reformulation.

### BACKGROUND

Food product manufacturing can include operations that combine a plurality of ingredients to create a malleable agglomeration that is then formed into a specific shape. For example, a food product such as a granola bar can include an agglomeration of ingredients such as nuts, oats, seeds, dried fruit, and a binder that holds the ingredients together. In a manufacturing process, such an agglomeration can be pressed into a mold to form a bar shape. The manufacturing process can include subsequent operations to produce a completed food product to be sold to consumers.

### SUMMARY

According to embodiments of the present disclosure, a method can include obtaining a set of images of a food product. The method can further include applying a trained machine learning model to the set of images to identify a feature of the food product. The method can further include modifying a formulation of the food product in response to identifying the feature.

According to embodiments of the present disclosure, a system can include one or more processors. The system can further include one or more computer-readable storage media storing program instructions which, when executed by the one or more processors, are configured to cause the one or more processors to perform a method. The method can include obtaining a set of images of a food product. The method can further include applying a trained machine learning model to the set of images to identify a feature of the food product. The method can further include modifying a formulation of the food product in response to identifying the feature.

According to embodiments of the present disclosure, a computer program product can include one or more computer readable storage media. The computer program product can further include program instructions collectively stored on the one or more computer readable storage media. The program instructions can include instructions configured to cause one or more processors to perform a method. The method can include obtaining a set of images of a food product. The method can further include applying a trained machine learning model to the set of images to identify a feature of the food product. The method can further include modifying a formulation of the food product in response to identifying the feature.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 depicts an example environment in which a reformulation management system can be implemented, in accordance with embodiments of the present disclosure.

FIG. 2 depicts a flowchart of an example method for reformulating a food product, in accordance with embodiments of the present disclosure.

FIG. 3 depicts a flowchart of an example method for training a machine learning model, in accordance with embodiments of the present disclosure.

FIG. 4 depicts example images that can be generated during training of a machine learning model, in accordance with embodiments of the present disclosure.

FIG. 5 is a block diagram depicting an illustrative computing device that can be used in accordance with embodiments of the present disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The present disclosure relates to food product manufacturing; more particular aspects relate to vision-based food product reformulation. As noted above, in manufacturing a food product such as a granola bar, ingredients such as nuts, oats, seeds, dried fruit, and a binder can be combined and then forced into a mold to form a bar shape. Other food product manufacturing operations can apply various forces to ingredients as well. For example, in a sheeting process, a roller can apply shearing and frictional forces while compressing a layer of ingredients that can afterward be cut into pieces. In an extrusion process, a feed screw can apply shearing and frictional forces while forming ingredients that can afterward be cut or pinched into smaller pieces. The forces applied to the ingredients during such operations can pulverize the ingredients and form particulates, such as crushed nuts and seeds. In some instances, such particulates can accumulate and form an undesired visible feature (e.g., a particulate mask layer) on the food product, which may negatively affect the taste, texture, and/or appearance of the food product. In some instances, the appearance of such a layer may be similar to the appearance of a surface of the food product; thus, the layer may be difficult to detect during an inspection of the food product.

To address these and other challenges, embodiments of the present disclosure include a reformulation management system that can be used in connection with manufacturing a variety of food products. In some embodiments, the reformulation management system can employ a trained machine learning model to detect the presence of a target object (e.g., a particulate mask layer) on a surface of a food product or to detect another visible feature of a food product. In some embodiments, in response to such a detection, the reformulation management system can generate a notification (e.g., a text instruction displayed to a user) to modify a quantity of one or more ingredients supplied to manufacture the food product. In some embodiments, in response to such a detection, the reformulation management system can autonomously modify a quantity of one or more ingredients supplied to manufacture the food product. By initiating such a reformulation (e.g., ingredient modification) of the food product, the reformulation management system can reduce the likelihood that the target object (or other visible feature) will form on a surface of the food product during a manufacturing process for the food product. By initiating such vision-based reformulation of a food product, embodiments of the present disclosure can accurately and efficiently detect undesired visible features of a food product and efficiently implement corrective measures (e.g., by changing one or more aspects of how the food product is manufactured, including reformulation). Accordingly, embodiments of the present disclosure can efficiently improve the output quality of a food product manufacturing process.

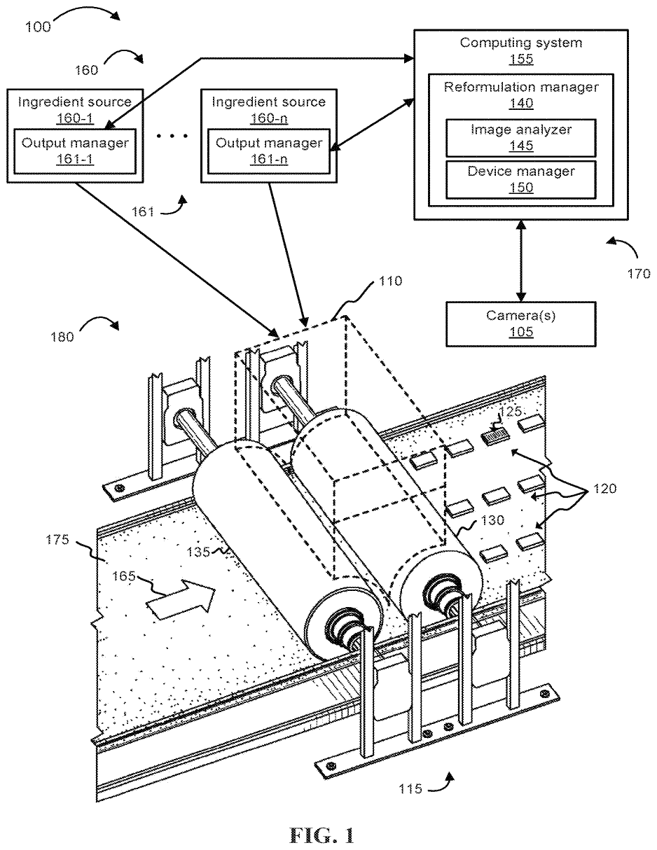

Turning to the figures, FIG. 1 illustrates a food product manufacturing environment 100 that includes an example food product production line 180 and a reformulation management system 170. Food product production line 180 includes a feed roller 135, a mold roller 130, a conveyor 175, and a hopper 110, supported by mechanical support equipment 115 (e.g., fasteners, brackets, mounting structures, motors, and the like). Food product production line 180 further includes a set of ingredient sources 160. The set of ingredient sources 160 can include receptacles (e.g., storage containers) configured to store ingredients for manufacturing food products 120. The set of ingredient sources 160 can include one or more ingredient sources. For example, in some embodiments, the set of ingredient sources 160 can include n ingredient sources, where n is an integer greater than 0. For example, n=1 in embodiments in which the set of ingredient sources 160 includes only a first ingredient source 160-1; n=2 in embodiments in which the set of ingredient sources 160 includes two ingredient sources (a first ingredient source 160-1 and a second ingredient source 160-2); and so on. Each of the set of ingredient sources 160 includes a respective output manager 161-n. Each output manager 161-n can include a flow control device (e.g., a pump, valve, and the like) configured to manipulate an output of an ingredient stored in a corresponding ingredient source. For example, a first ingredient source 160-1 can store maltodextrin, and a respective output manager 161-1 can include a valve that can start or stop a flow of the maltodextrin from the first ingredient source 160-1. Continuing with this example, a second ingredient source 160-2 can store water, and a respective output manager 161-2 can include a pump that can increase or decrease a flow of the water from the second ingredient source 160-2. Further in this example, a third ingredient source 160-3 can store emulsifier (e.g., lecithin, monoglycerides, mono-and diglycerides, and the like), and a respective output manager 161-3 can include a pump that can increase or decrease a flow of the emulsifier from the third ingredient source 160-3. Each output manager 161-n can be configured to communicate with computing system 155, as discussed further below.

In an example operation of food product production line 180, conveyor 175 moves in the direction of arrow 165. The set of output managers 161 can supply ingredients for food products to 120 hopper 110. For example, an output manager can open a valve to initiate a flow of an ingredient through a conduit to hopper 110. In some embodiments, one or more of the set of output managers 161 can supply ingredients to a mixing device, and the mixing device can be configured to output mixed ingredients to hopper 110. Such a mixing device can include a receptacle having an agitating structure, such as a blade, configured to mix ingredients. Hopper 110 can dispense a mixture of ingredients, such as a dough that includes fragments of nuts, seeds, and dried fruit. Feed roller 135 can press the mixture of ingredients into cavities of mold roller 130 to shape the mixture of ingredients into discrete bar-shaped food products 120. In some instances, the forces applied to the mixture of ingredients during such an operation can cause a particulate mask layer 125 (e.g., a visible layer of ingredient fragments, such as a mass of ground-up dry particulate ingredients, such as nut, seed, and/or puffed grain particles) to form on a surface of food products 120. For example, in some instances, the pressing of the ingredient mixture by the feed roller 135 into cavities of the mold roller 130 can apply frictional forces that crush ingredients and smear crushed ingredient particulates onto a surface of the ingredient mixture. Such ingredient particulates can appear as mask layer 125 on some food products 120 released from cavities of the mold roller 130.

Reformulation management system 170 can include a computing system 155 and one or more cameras 105. Reformulation management system 170 can be configured to detect the presence of particulate mask layer 125 and initiate a modification of an output from one or more of the set of ingredient sources 160 in response to such a detection. For example, one or more cameras 105 can be positioned to capture images of one or more food products 120 on the conveyor 175. The one or more cameras 105 can be configured to transmit the captured images to computing system 155. Computing system 155 can include a reformulation manager 140 configured to modify an output of an ingredient source based on an analysis of the images.

Computing system 155 can be configured to permit a user to view images and to input data. For example, computing system 155 can include a user interface (e.g., display, keyboard, touchscreen, and the like) permitting a user to view images and input data regarding images. Such an interface (e.g., display) can be configured to present information (e.g., notifications) to a user.

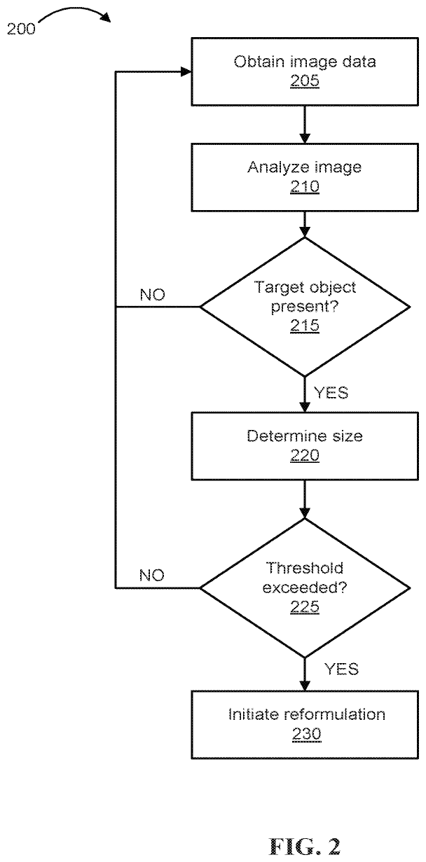

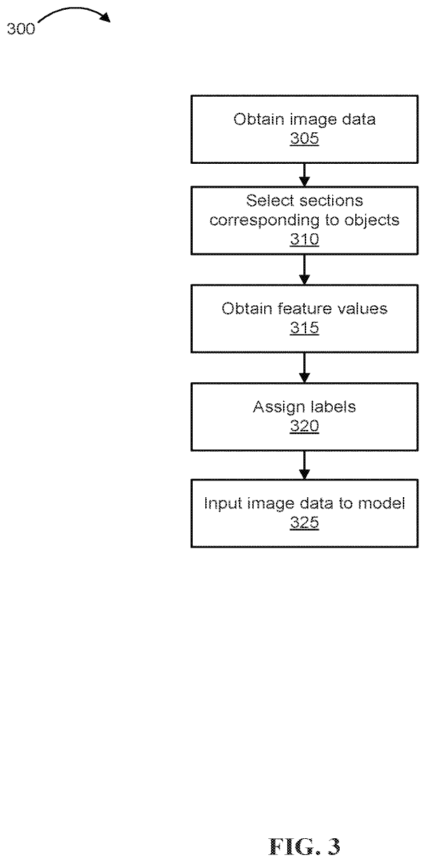

Reformulation manager 140 can be included as software installed on computing system 155. Reformulation manager 140 can include program instructions implemented by a processor, such as a processor of computing system 155, to perform one or more operations discussed with respect to FIG. 2 and/or FIG. 3. In some embodiments, reformulation manager 140 can include one or more modules, such as image analyzer 145 and device manager 150. Image analyzer 145 can be configured to analyze images obtained from the one or more cameras 105. For example, in some embodiments, image analyzer 145 can include image analysis software such as machine learning models configured to perform image processing operations (e.g., feature detection, classification, segmentation, and the like). Accordingly, in some embodiments, image analyzer can be configured to perform operations 205-225, FIG. 2. In some embodiments, image analyzer 145 can include a random forest classifier. Device manager 150 can be configured to manage the one or more cameras 105 and/or one or more of the set of output managers 161. For example, in some embodiments, device manager 150 can issue a command to a camera 105 to cause the camera 105 to capture images of food products 120. In some embodiments, device manger 150 can issue a command to an output manager 161-n to modify (e.g., increase or decrease) a quantity of an ingredient supplied from an ingredient source 160-n. In some embodiments, device manager 150 can generate a notification (e.g., a text instruction displayed to a user) to modify a quantity of one or more ingredients supplied to manufacture the food product. Accordingly, in some embodiments, device manager 150 can be configured to perform operation 230, FIG. 2.

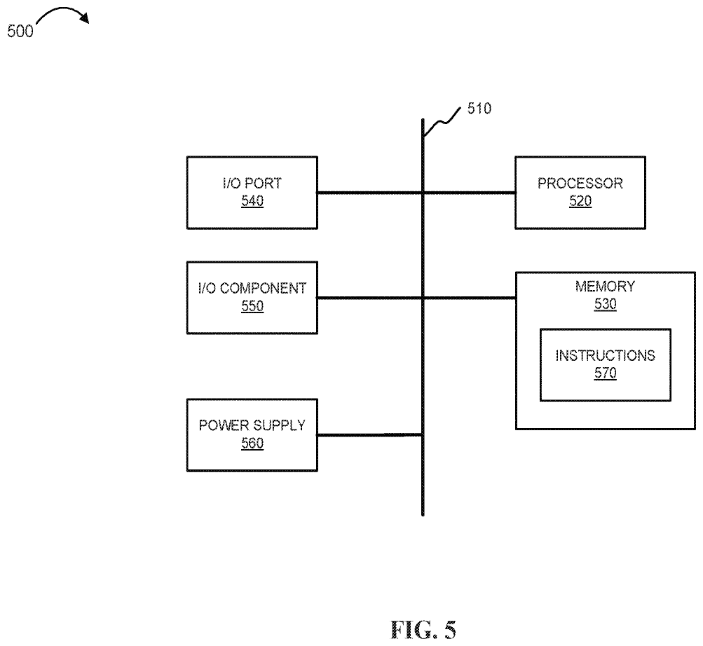

Computing system 155 can exchange data with one or more output managers 161-n and/or one or more cameras 105 through at least one network, such as a wide area network (WAN), a local area network (LAN), the internet, or an intranet. Computing system 155, one or more of the set of output managers 161, and/or one or more cameras 105 can include a computing device, such as illustrative computing device 500, FIG. 5.

FIG. 2 depicts a flowchart of an example method 200 for reformulating a food product, in accordance with embodiments of the present disclosure. Method 200 can be performed by reformulation manager 140, FIG. 1.

In operation 205, the reformulation manager can obtain image data (e.g., a set of images) of one or more food products. In some embodiments, operation 205 can include the reformulation manager receiving one or more images in response to issuing a command to a camera to capture the one or more images. In some embodiments, operation 205 can include the reformulation manager retrieving image data from a storage location, such as from memory of a computing device.

In operation 210, the reformulation manager can analyze the image data obtained in operation 205. In some embodiments, operation 210 can include the reformulation manager employing image analysis software such as machine learning models configured to perform image processing operations (e.g., feature detection, classification, segmentation, and the like). For example, the reformulation manager can apply a trained machine learning model (e.g., a random forest classifier) to image data to identify a visible feature (e.g., a mask layer) of a food product image. In some embodiments, applying a trained machine learning model to image data can include inputting such image data into a trained machine learning algorithm.

In operation 215, the reformulation manager can determine whether a target object is present, based on the analysis performed in operation 210. For example, operation 215 can include the reformulation manager determining that a target object (e.g., a mask layer) is present in response to image processing performed in operation 210. In some embodiments, a target object can be a visible feature to be identified in an image. In some embodiments, the target object can be selected by a user/operator of the reformulation manager. If the reformulation manager determines that the target object is present, then, in some embodiments, the reformulation manager can proceed to operation 220. In some embodiments, if the reformulation manager determines that the target object is present, then the reformulation manager can proceed to operation 230. Alternatively, if the reformulation manager determines that the target object is not present, then the reformulation manager can proceed to operation 205.

In operation 220, in some embodiments, the reformulation manager can determine, based on image data obtained in operation 205, a size of the target object. For example, for the case in which the target object is a mask layer, the reformulation manager can calculate an area of the mask layer relative to an area of the surface of the food product upon which the mask layer is disposed. In an example, the reformulation manager can calculate that the mask layer covers 30% of a surface of the food product.

In operation 225, in some embodiments, the reformulation manager can determine whether the size determined in operation 220 exceeds a threshold. Continuing with the example discussed above, the reformulation manager can determine that the 30% coverage of the mask layer exceeds a preselected threshold of 25%. In some embodiments, the threshold can be selected by a user/operator of the reformulation manager. If the reformulation manager determines that the threshold is exceeded, then the reformulation manager can proceed to operation 230. Alternatively, if the reformulation manager determines that the threshold is not exceeded, then the reformulation manager can proceed to operation 205. In this way, embodiments of the present disclosure can permit tailored vision-based food product reformulation.

In operation 230, the reformulation manager can initiate a reformulation of the food product. In some embodiments, operation 230 can include the reformulation manager generating an instruction to change a quantity of one or more ingredients supplied for manufacturing the food product. For example, in some embodiments, a food product can include a binder that contains the ingredients maltodextrin, water, and emulsifier. In a manufacturing process for the food product (e.g., the manufacturing process described with respect to FIG. 1), these ingredients can be supplied from a maltodextrin source, a water source, and an emulsifier source to produce the food product. In this example, the reformulation manager can initiate a reformulation of the food product by generating a notification (e.g., a text instruction displayed to a user) to modify a quantity of the maltodextrin, water, and/or emulsifier supplied to produce the food product. In some instances, such a notification can further indicate the quantity (e.g., percentage increase or decrease, or numeric value (e.g., 100 mL)) that the maltodextrin, water, and/or emulsifier should be increased or decreased. Accordingly, based on the instruction, a user (e.g., an operator of the manufacturing process equipment) can modify a quantity of one or more ingredients supplied for manufacturing the food product. For example, in accordance with an instruction from the reformulation manager, such a user can adjust a setting of a device (e.g., output manager 161-n, FIG. 1) such that it increases a flowrate of water supplied for manufacturing the food product. In some embodiments, the reformulation manager can initiate a reformulation of the food product by issuing a command to a device (e.g., output manager 161-n, FIG. 1) to change a quantity (e.g., flowrate, mass, volume) of one or more ingredients supplied for manufacturing the food product. Accordingly, in some embodiments, the reformulation manager can autonomously perform a reformulation of a food product.

By initiating a reformulation, embodiments of the present disclosure can reduce the likelihood that a target object (e.g., a particulate mask layer or other visible feature) will form on the food product during a manufacturing process for the food product. In some embodiments, operation 230 can be based, at least in part, on historical data obtained by the reformulation manager from a data storage location (e.g., memory of a computing device). Such historical data can include previously determined correlations between changes in ingredient quantities and the presence of a target object. For example, in some instances, decreasing a food product composition of maltodextrin from 9% to 6% can reduce the size and/or presence of a particulate mask layer on the food product. In some instances, the reformulation manager can initiate a reformulation (e.g., reduce a food product composition of maltodextrin) based on such historical data. In some embodiments, the historical data can include statistical analyses of correlations between changes in ingredient quantities and the presence of a target object.

FIG. 3 depicts a flowchart of an example method 300 for training a machine learning model (e.g., a random forest classifier), in accordance with embodiments of the present disclosure. In some embodiments, method 300 can be performed by a user training reformulation manager 140, FIG. 1.

In operation 305, the reformulation manager can obtain image data (e.g., a set of images) of one or more food products. Operation 305 can be substantially similar to operation 205, FIG. 2.

In operation 310, a user can select sections of an image obtained in operation 305 for labeling. For example, in training the machine learning model to distinguish a food product from a conveyor in an image, a user can select a set of pixels of the image that correspond to the food product to have a first label. Next, the user can select a second set of pixels of the image that correspond to the conveyor to have a second label.

In operation 315, the reformulation manager can obtain a set of feature values corresponding to the pixels of the image. The set of feature values can include numerical values corresponding to features such as intensity, edge, and texture of each pixel of the image. In some embodiments, operation 315 can include the reformulation manager calculating the set of feature values by image processing software. In some embodiments, operation 315 can include the reformulation manager retrieving the set of feature values from a storage location, such as from memory of a computing device.

In operation 320, the user and/or the reformulation manager can assign labels to sections selected in operation 310. For example, in some embodiments, a user can assign a purple color to the set of pixels of the image that correspond to the food product. Further in this example, the user can assign a yellow color to the set of pixels of the image that correspond to the conveyor. In another example, the reformulation manager can assign a first range of numerical values indicating texture to the set of pixels of the image that correspond to the food product. Further in this example, the reformulation manager can assign a second range of numerical values indicating texture to the set of pixels of the image that correspond to the conveyor.

In operation 325, the user and/or the reformulation manager can input the image data, including the assigned labels into the machine learning model. Based on such data, the machine learning model can segment the image (e.g., distinguish objects of the image).

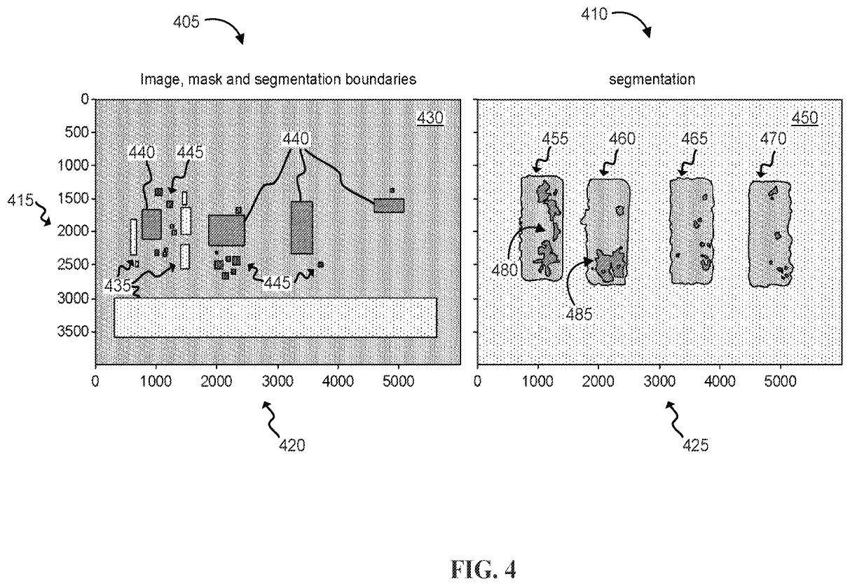

FIG. 4 depicts an example image 405 and an example segmented image 410 that can be generated during training of a machine learning model, in accordance with embodiments of the present disclosure. For example, images 405 and 410 can be generated during operations of method 300. In some embodiments, X-axes 420, 425 and Y-axis 415 indicate pixel coordinates for images 405 and 410. Image 405 represents an image of a food product (e.g., snack bar 120, FIG. 1) obtained by an image-capture device (e.g., camera 105, FIG. 1). Image 405 includes portions of other identifiable objects, as described below. Section 430 indicates a selected set of pixels of the image 405 that correspond to a surface of the food product. Sections 440 indicate selected sets of pixels of the image 405 that correspond to surfaces of a particulate mask layer on the food product. Sections 445 indicate selected sets of pixels of the image 405 that correspond to various particulates on the food product. Sections 435 indicate selected sets of pixels of the image 405 that correspond to a support platform (e.g., conveyor 115, FIG. 1) upon which the food product is disposed. This section data can be combined with additional image processing data, such as calculated values for intensity, edge, and texture features of each pixel of image 405, and input into a machine learning model, such as a random forest classifier. Based on the combined data, the machine learning model can generate segmented image 410.

Segmented image 410 shows different objects identified by the machine learning model. For example, segmented image 410 shows four food products 455, 460, 465, and 470 that were identified based, at least in part, on section 430. Support platform 450 was identified based, at least in part, on sections 435. Additionally, particulate mask layers 480, 485 were identified based, at least in part, on sections 440.

FIG. 5 is a block diagram depicting an illustrative computing device 500, in accordance with embodiments of the disclosure. The computing device 500 may include any type of computing device suitable for implementing aspects of embodiments of the disclosed subject matter. Examples of computing devices include specialized computing devices or general-purpose computing devices such as workstations, servers, laptops, desktops, tablet computers, hand-held devices, smartphones, general-purpose graphics processing units (GPGPUs), and the like. Each of the various components shown and described in the Figures can contain their own dedicated set of computing device components, such as those shown in FIG. 5 and described below. For example, the computing system 155, FIG. 1 and the one or more cameras 105, FIG. 1 can each include a set of components shown in FIG. 5 and described below.

In embodiments, the computing device 500 includes a bus 510 that, directly and/or indirectly, couples one or more of the following devices: a processor 520, a memory 530, an input/output (I/O) port 540, an I/O component 550, and a power supply 560. Any number of additional components, different components, and/or combinations of components may also be included in the computing device 500.

The bus 510 represents what may be one or more busses (such as, for example, an address bus, data bus, or combination thereof). Similarly, in embodiments, the computing device 500 may include a number of processors 520, a number of memory components 530, a number of I/O ports 540, a number of I/O components 550, and/or a number of power supplies 560. Additionally, any number of these components, or combinations thereof, may be distributed and/or duplicated across a number of computing devices.

In embodiments, the memory 530 includes computer-readable media in the form of volatile and/or nonvolatile memory and may be removable, nonremovable, or a combination thereof. Media examples include random access memory (RAM); read only memory (ROM); electronically erasable programmable read only memory (EEPROM); flash memory; optical or holographic media; magnetic cassettes, magnetic tape, magnetic disk storage or other magnetic storage devices; data transmissions; and/or any other medium that can be used to store information and can be accessed by a computing device. In embodiments, the memory 530 stores computer-executable instructions 570 for causing the processor 520 to implement aspects of embodiments of components discussed herein and/or to perform aspects of embodiments of methods and procedures discussed herein. The memory 530 can comprise a non-transitory computer readable medium storing the computer-executable instructions 570. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-executable instructions 570 may include, for example, computer code, machine-useable instructions, and the like such as, for example, program components capable of being executed by one or more processors 520 (e.g., microprocessors) associated with the computing device 500. Program components may be programmed using any number of different programming environments, including various languages, development kits, frameworks, and/or the like. Some or all of the functionality contemplated herein may also, or alternatively, be implemented in hardware and/or firmware.

According to embodiments, for example, the instructions 570 may be configured to be executed by the processor 520 and, upon execution, to cause the processor 520 to perform certain processes. In certain embodiments, the processor 520, memory 530, and instructions 570 are part of a controller such as an application specific integrated circuit (ASIC), field-programmable gate array (FPGA), and/or the like. Such devices can be used to carry out the functions and steps described herein.

The I/O component 550 may include a presentation component configured to present information to a user such as, for example, a display device, a speaker, and/or the like, and/or an input component such as, for example, a microphone, a joystick, a satellite dish, a wireless device, a keyboard, a pen, a voice input device, a touch input device, a touch-screen device, an interactive display device, a mouse, and/or the like.

The devices and systems described herein can be communicatively coupled via a network, which may include a local area network (LAN), a wide area network (WAN), a cellular data network, via the internet using an internet service provider, and the like.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, can be implemented by computer program instructions.

Various modifications and additions can be made to the exemplary embodiments discussed without departing from the scope of the disclosed subject matter. For example, while the embodiments described above refer to particular features, the scope of this disclosure also includes embodiments having different combinations of features and embodiments that do not include all of the described features. Accordingly, the scope of the disclosed subject matter is intended to embrace all such alternatives, modifications, and variations as fall within the scope of the claims, together with all equivalents thereof.

1. A method comprising:
obtaining a set of images of a food product;
applying a trained machine learning model to the set of images to identify a feature of the food product; and
modifying a formulation of the food product in response to identifying the feature.

2. The method of claim 1, wherein the trained machine learning model comprises a random forest algorithm.

3. The method of claim 1, wherein the feature comprises a particulate mask.

4. The method of claim 3, wherein the identifying further comprises:
calculating a relative coverage area of the particulate mask, and determining that the relative coverage area exceeds a threshold.

5. The method of claim 1, wherein the modifying comprises changing a quantity of one or more ingredients in a manufacturing process for the food product.

6. The method of claim 1, wherein the food product comprises a binder, and wherein the modifying comprises changing one or more ingredients of the binder.

7. The method of claim 6, wherein the one or more ingredients comprises maltodextrin, water, or an emulsifier.

8-9. (canceled)

10. A system comprising: one or more processors; and one or more computer-readable storage media storing program instructions which, when executed by the one or more processors, are configured to cause the one or more processors to perform a method comprising:
obtaining a set of images of a food product;
applying a trained machine learning model to the set of images to identify a feature of the food product; and
modifying a formulation of the food product in response to identifying the feature.

11. The system of claim 10, wherein the trained machine learning model comprises a random forest algorithm.

12. The system of claim 10, wherein the feature comprises a particulate mask.

13. The system of claim 12, wherein the identifying further comprises:
calculating a relative coverage area of the particulate mask, and
determining that the relative coverage area exceeds a threshold.

14. The system of claim 10, wherein the modifying comprises changing a quantity of one or more ingredients in a manufacturing process for the food product.

15. The system of claim 10, wherein the food product comprises a binder, and wherein the modifying comprises changing one or more ingredients of the binder.

16. The system of claim 15, wherein the one or more ingredients comprises maltodextrin, water, or an emulsifier.

17-18. (canceled)

19. A computer program product comprising one or more computer readable storage media, and program instructions collectively stored on the one or more computer readable storage media, the program instructions comprising instructions configured to cause one or more processors to perform a method comprising:
obtaining a set of images of a food product;
applying a trained machine learning model to the set of images to identify a feature of the food product; and
modifying a formulation of the food product in response to identifying the feature.

20. The computer program product of claim 19, wherein the trained machine learning model comprises a random forest algorithm.

21. The computer program product of claim 19, wherein the feature comprises a particulate mask.

22. The computer program product of claim 21, wherein the identifying further comprises:
calculating a relative coverage area of the particulate mask, and
determining that the relative coverage area exceeds a threshold.

23. The computer program product of claim 19, wherein the modifying comprises changing a quantity of one or more ingredients in a manufacturing process for the food product.

24. The computer program product of claim 19, wherein the food product comprises a binder, and
wherein the modifying comprises changing one or more ingredients of the binder.

25. The computer program product of claim 24, wherein the one or more ingredients comprises maltodextrin, water, or an emulsifier.

26-27. (canceled)
